(19) United States
(12) Patent Application Publication
(10) Pub. No.: US 2012/0268775 A1
(43) Pub. Date: Oct. 25, 2012

(54) PORTABLE STANDALONE CONTROLLER FOR OPTICAL DISC LABEL PRINTERS

(76) Inventors: Shuo-Wei Chang, Alhambra, CA (US); Wei-Cheng Chu, Alhambra, CA (US)

(21) Appl. No.: 13/093,827

(22) Filed: Apr. 25, 2011

(51) Int. Cl. G06F 3/12

(52) U.S. Cl. 358/1.15

(57) ABSTRACT

A portable standalone controller for optical disc label printers has at least one output port and a processing unit. The at least one output port is for connecting to at least one optical disc label printer. The processing unit connects to the at least one output, receives label content, transmits the received label content to the at least one connected optical disc label printer through the at least one output port and issues at least one printing command to the at least one connected optical disc label printer so the at least one connected optical disc label printer starts to label according to the label content. The controller connects to a computer or an external device only for acquiring the label content. The controller allows users to use the connected optical disc label printer without operating a corresponding computer.

### BACKGROUND OF THE INVENTION

1. Field of the Invention

The present invention relates to a controller for optical disc label printers, and more particularly to a portable standalone controller for optical disc label printers.

2. Description of Related Art

Optical discs including CD, DVD, Blu-ray and the like are popular data storage and exchange mediums of today. In order to label the optical discs, an easiest approach is to manually write on the optical discs with a pen or marker. Another easy approach is to print graphics on paper labels and stick the paper labels on the optical discs. However, the above-mentioned approaches are limited to simple texts or graphics and are not suitable for labeling a large volume of the optical discs.

In order to label complex graphics or even photos on the optical discs, a widely used approach nowadays is to use an optical disc label printer, which allows directly printing complex graphics or even photos on the optical discs. Existing optical disc label printers may comprise thermal type printers, inkjet type printers, silk screen type printers and the like.

With reference to FIG. 5, each optical disc label printer (81) has to connect to a corresponding computer (82). Drivers corresponding to the optical disc label printer (81) are installed in the corresponding computer (82) so the optical disc label printer (81) can be controlled by the corresponding computer (82). The optical disc label printer (81) receives label content and a printing command from the corresponding computer (82) so the optical disc label printer (81) starts to label the optical disc inserted therein.

However, users cannot control the optical disc label printers (81) without the corresponding computers (82). It is inconvenient and costly for users to provide and connect the computers (82) to the optical disc label printers (81) before using the optical disc label printers (81).

To overcome the shortcomings, the present invention provides a portable standalone controller for optical disc label printers to mitigate or obviate the aforementioned problems.

### SUMMARY OF THE INVENTION

The main objective of the invention is to provide a portable standalone controller for optical disc label printers.

The controller in accordance with the present invention comprises at least one output port and a processing unit. The at least one output port is for connecting to at least one optical disc label printer. The processing unit connects to the at least one output, receives label content, transmits the received label content to the at least one connected optical disc label printer through the at least one output port and issues at least one printing command to the at least one connected optical disc label printer so the at least one connected optical disc label printer starts to label according to the label content. The controller connects to a computer or an external device only for acquiring the label content. The controller allows users to use the connected optical disc label printer without controlling a corresponding computer. Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a first embodiment of a controller in accordance with the present invention;

FIG. 2 is a functional block diagram of a second embodiment of a controller in accordance with the present invention;

FIG. 3 is a flow chart of a label selection process executed by a processing unit in FIG. 2;

FIG. 4 is another flow chart of the label selection process executed by the processing unit in FIG. 2; and

FIG. 5 shows that conventionally each optical disc label printer has to operate by connecting to a corresponding computer.

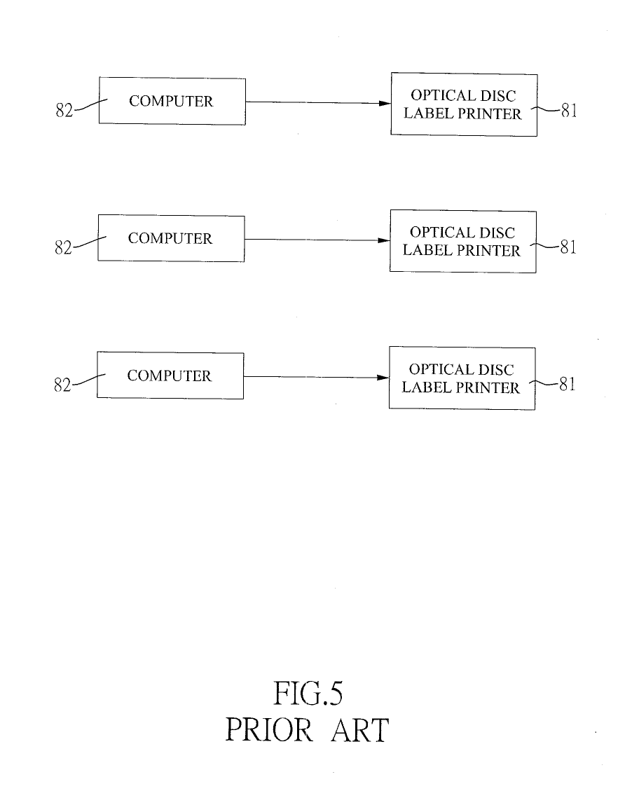

### DETAILED DESCRIPTION OF PREFERRED EMBODIMENT

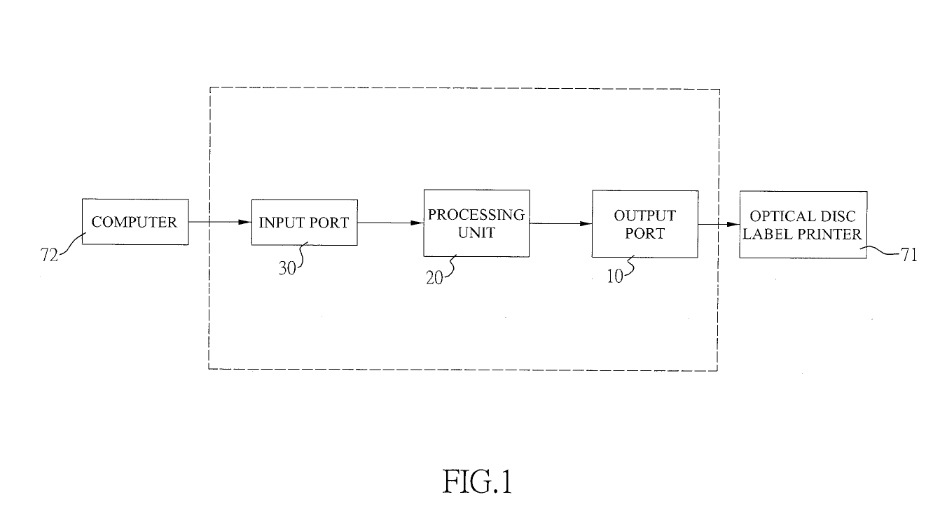

With reference to FIG. 1, a first embodiment of a portable standalone controller for optical disc label printers in accordance with the present invention comprises an output port (10), a processing unit (20) and an input port (30).

The output port (10) is for connecting to an optical disc label printer (71) via Parallel Advanced Technology Attachment (PATA) standard, Serial Advanced Technology Attachment (SATA) standard, Universal Serial Bus (USB) standard, Serial Port standard, Line Print Terminal (LPT) standard or the like.

The processing unit (20) connects to the output port (10) and stores drivers of the optical disc label printer (71) so the processing unit (20) is capable of recognizing and communicating with the connected optical disc label printer (71).

The input port (30) connects to the processing unit (20) and is capable of receiving and submitting label content from a computer (72) or an external device such as a removable flash disk drive to the processing unit (20). The processing unit (20) then transmits the received label content to the connected optical disc label printer (71) through the output port (10). The processing unit (20) also issues a printing command to the connected optical disc label printer (71) so the connected optical disc label printer (71) starts to label according to the label content. Further, the output port (10) may comply with PATA standard, SATA standard, USB standard, Serial Port standard, RJ45 Ethernet standard or the like.

Therefore, the controller of the present invention mentioned in the above first embodiment connects to a computer (72) or an external device only for acquiring the label content. The controller of the present invention allows users to use the connected optical disc label printer (71) without controlling a corresponding computer (72).

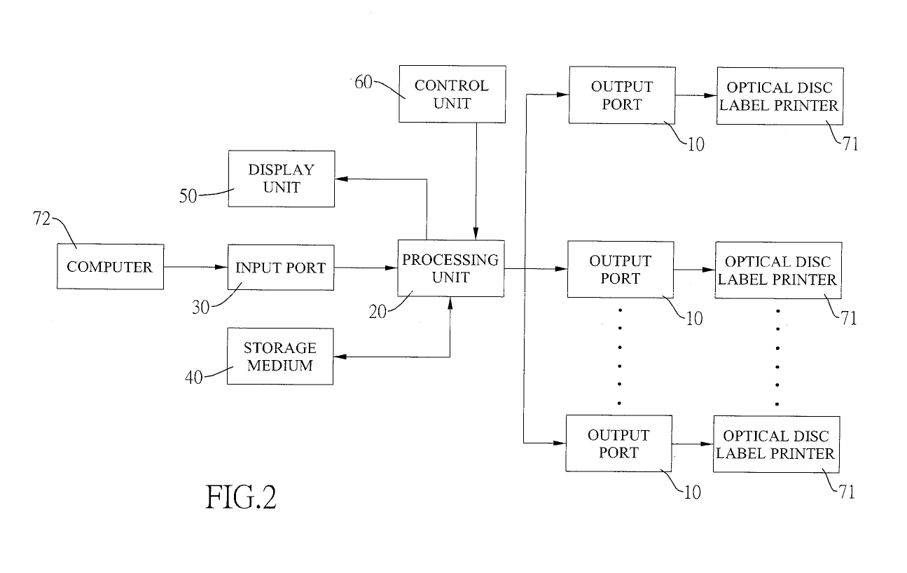

With reference to FIG. 2, a second embodiment of the present invention is similar to the above-mentioned first embodiment. Differences between the two embodiments are that the second embodiment of the present invention further comprises multiple output ports (10), a storage medium (40), a display unit (50) and a control unit (60).

The output ports (10) are for connecting respectively to multiple optical disc label printers (71).

The processing unit (20) is capable of determining whether the output ports (10) connect to corresponding optical disc label printers (71) and has a label selection process.

The storage medium (40) connects to the processing unit (20) and is for storing the label content received from the input port (30). Preferably, the storage medium (40) may be a hard disk drive, a flash memory, a flash-memory based device such as a solid-state drive, or the like. When the input port (30) is connected to a computer (72), the storage medium (40) will be treated as a removable storage device to allow the computer (72) to transmit the label content thereto through the input port (30).

The display unit (50) connects to the processing unit (20) to show multiple port statuses and a content record. The port statuses correspond respectively to the output ports (10), and each port status represents whether a corresponding output port (10) connects to the optical disc label printer (71). The content record lists label content(s) stored in the storage medium (40).

The control unit (60) connects and transmits at least one label selection command and at least one printer designated command to the processing unit (20). Each label selection command corresponds to one label content, and each printer designated command corresponds to one connected optical disc label printer (71). Further, the control unit (60) may be a control panel with buttons, a touch panel display combined with the display unit (50) or the like to allow a user to control the controller of the present invention. In addition, if the input port (30) is connected to an external device such as a removable flash disk drive, the user can operate the control unit (60) to issue a copy command to the processing unit (20) so the processing unit (20) copies label content from the connected external device to the storage medium (40).

When the processing unit (20) receives the at least one label selection command and the at least one printer designated command, the processing unit (20) executes the label selection process to retrieve at least one label content from the storage medium (40) according to the at least one label selection command and transmit the retrieved label content and one or multiple printing commands to one or multiple connected optical disc label printers (71) according to the at least one printer designated command. Therefore, the label contents stored in the storage medium (40) and the connected optical disc label printers (71) are selectable and assignable based on different applications or the user's requirement.

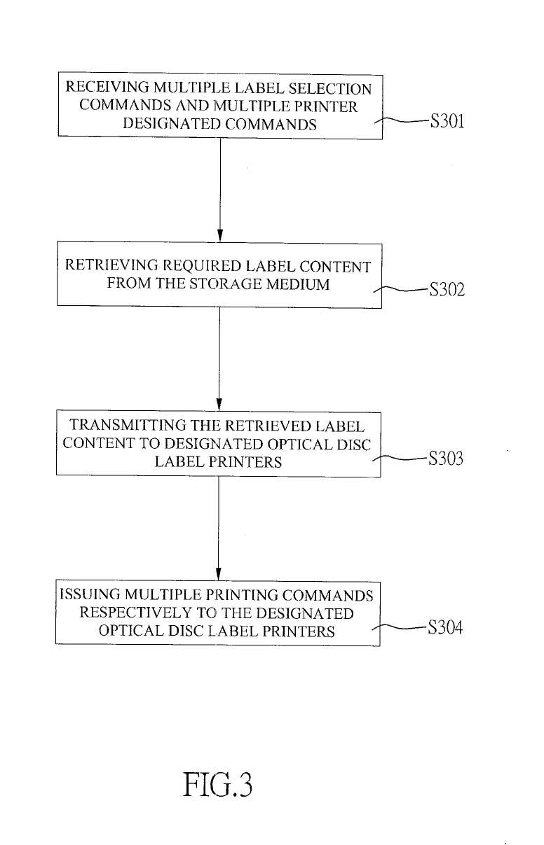

With further reference to FIG. 3, if the user intends to designate all connected optical disc label printers (71) to label according to the same label content, the label selection process comprises steps of receiving multiple label selection commands and multiple printer designated commands (S301), retrieving the required label content from the storage medium (S302), transmitting the retrieved label content to designated optical disc label printers (S303), issuing multiple printing commands respectively to the designated optical disc label printers (S304).

In the step of receiving multiple label selection commands and multiple printer designated commands (S301), the processing unit (20) receives multiple label selection commands for selecting the same label content stored in the storage medium (40) and multiple printer designated commands for designating all connected optical disc label printers (71) to label.

In the step of retrieving the required label content from the storage medium (S302), the processing unit (20) retrieves the label content selected by the label selection commands from the storage medium (40).

In the step of transmitting the retrieved label content to designated optical disc label printers (S303), the processing unit (20) transmits the retrieved label content to the optical disc label printers (71) designated by the printer designated commands.

In the step of issuing multiple printing commands respectively to the designated optical disc label printers (S304), the processing unit (20) issues multiple printing commands respectively to the designated optical disc label printers (71).

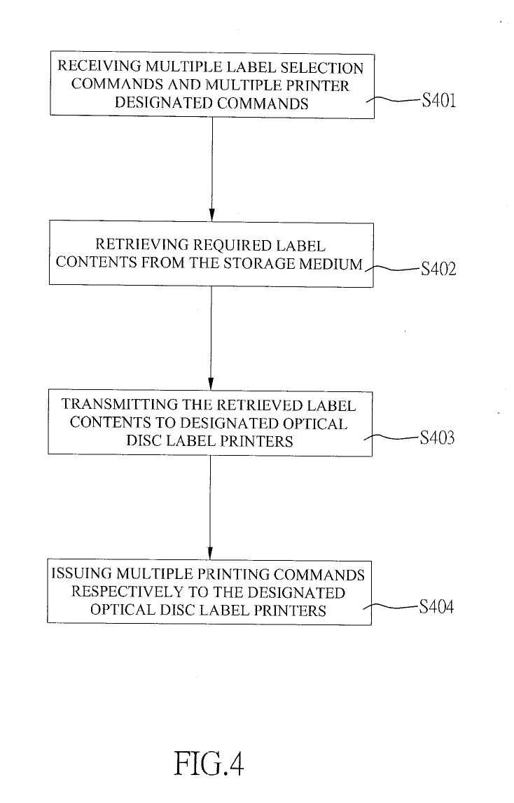

With further reference to FIG. 4, if the user intends to designate all connected optical disc label printers (71) to label respectively according to different label contents, the label selection process comprises steps of receiving multiple label selection commands and multiple printer designated commands (S401), retrieving the required label contents from the storage medium (S402), transmitting the retrieved label contents to designated optical disc label printers (S403), issuing multiple printing commands respectively to the designated optical disc label printers (S404).

In the step of receiving multiple label selection commands and multiple printer designated commands (S401), the processing unit (20) receives multiple label selection commands for selecting different label contents stored in the storage medium (40) and multiple printer designated commands for designating all connected optical disc label printers (71) to label.

In the step of retrieving the required label contents from the storage medium (S402), the processing unit (20) retrieves the label contents selected by the label selection commands from the storage medium (40).

In the step of transmitting the retrieved label contents to designated optical disc label printers (S403), the processing unit (20) transmits the retrieved label contents respectively to the optical disc label printers (71) designated by the printer designated commands.

In the step of issuing multiple printing commands respectively to the designated optical disc label printers (S404), the processing unit (20) issues multiple printing commands respectively to the designated optical disc label printers (71).

Based on the foregoing descriptions, the controller in the second embodiment of the present invention not only performs as a removable storage device to retrieve the label content from the computer (72), but also allows the user to either select the required label content stored in the storage medium (40) or designate one or multiple connected optical disc label printers (71) to label. Therefore, it is convenient and economical for the user to use the controller of the present invention without using the computer (72) to control the optical disc label printer (71).

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A portable standalone controller for optical disc label printers comprising:
at least one output port for connecting to at least one optical disc label printer;
a processing unit connecting to the at least one output port, receiving label content, transmitting the received label content to the at least one connected optical disc label printer through the at least one output port and issuing at least one printing command to the at least one connected optical disc label printer so the at least one connected optical disc label printer starts to label according to the label content.

2. The controller as claimed in claim 1 further comprising an input port, wherein the input port connects to the processing unit and is capable of receiving and submitting the label content to the processing unit.

3. The controller as claimed in claim 2 further comprising a storage medium, wherein the storage medium connects to the processing unit and is for storing the label content.

4. The controller as claimed in claim 1 further comprising a storage medium, a display unit and a control unit, wherein
multiple output ports are implemented for connecting respectively to multiple optical disc label printers;
the processing unit is capable of determining whether the output ports connect to corresponding optical disc label printers and has a label selection process;
the storage medium connects to the processing unit and is for storing the label content;
the display unit connects to the processing unit to show
multiple port statuses corresponding respectively to the output ports, and each port status representing whether a corresponding output port connects to the optical disc label printer; and
a content record listing the label contents stored in the storage medium;
the control unit connects to the processing unit and transmits at least one label selection command and at least one printer designated command to the processing unit, and each label selection command corresponds to one label content, and each printer designated command corresponds to one connected optical disc label printer; and
when the processing unit receives the at least one label selection command and the at least one printer designated command, the processing unit executes the label selection process to retrieve at least one label content from the storage medium according to the at least one label selection command and transmit the retrieved label content and at least one printing command to at least one connected optical disc label printer according to the at least one printer designated command.

5. The controller as claimed in claim 2 further comprising a storage medium, a display unit and a control unit, wherein
multiple output ports are implemented for connecting respectively to multiple optical disc label printers;
the processing unit is capable of determining whether the output ports connect to corresponding optical disc label printers and has a label selection process;
the storage medium connects to the processing unit and is for storing the label content;
the display unit connects to the processing unit to show
multiple port statuses corresponding respectively to the output ports, and each port status representing whether a corresponding output port connects to the optical disc label printer; and
a content record listing the label content stored in the storage medium;
the control unit connects to the processing unit and transmits at least one label selection command and at least one printer designated command to the processing unit, and each label selection command corresponds to one label content, and each printer designated command corresponds to one connected optical disc label printer; and
when the processing unit receives the at least one label selection command and the at least one printer designated command, the processing unit executes the label selection process to retrieve at least one label content from the storage medium according to the at least one label selection command and transmit the retrieved label content and at least one printing command to at least one connected optical disc label printer according to the at least one printer designated command.

6. The controller as claimed in claim 4, wherein the label selection process comprises steps of:
receiving multiple label selection commands and multiple printer designated commands, and the label selection commands being for selecting the same label content stored in the storage medium, and the printer designated commands being for designating all connected optical disc label printers to label;
retrieving the label content selected by the label selection commands from the storage medium;
transmitting the retrieved label content to the optical disc label printers designated by the printer designated commands; and
issuing multiple printing commands respectively to the designated optical disc label printers.

7. The controller as claimed in claim 5, wherein the label selection process comprises steps of:
receiving multiple label selection commands and multiple printer designated commands, and the label selection commands being for selecting the same label content stored in the storage medium, and the printer designated commands being for designating all connected optical disc label printers to label;
retrieving the label content selected by the label selection commands from the storage medium;
transmitting the retrieved label content to the optical disc label printers designated by the printer designated commands; and
issuing multiple printing commands respectively to the designated optical disc label printers.

8. The controller as claimed in claim 4, wherein the label selection process comprises steps of:
receiving multiple label selection commands and multiple printer designated commands, and the label selection commands being for selecting different label contents stored in the storage medium, and the printer designated commands being for designating all connected optical disc label printers to label;
retrieving the label contents selected by the label selection commands from the storage medium;
transmitting the retrieved label contents respectively to the optical disc label printers designated by the printer designated commands; and
issuing multiple printing commands respectively to the designated optical disc label printers.

9. The controller as claimed in claim 5, wherein the label selection process comprises steps of:
receiving multiple label selection commands and multiple printer designated commands, and the label selection commands being for selecting different label contents stored in the storage medium, and the printer designated commands being for designating all connected optical disc label printers to label;
retrieving the label contents selected by the label selection commands from the storage medium;
transmitting the retrieved label contents respectively to the optical disc label printers designated by the printer designated commands; and
issuing multiple printing commands respectively to the designated optical disc label printers.

10. The controller as claimed in claim 4, wherein the display unit and the control unit are combined together.

11. The controller as claimed in claim 5, wherein the display unit and the control unit are combined together.

12. The controller as claimed in claim 6, wherein the display unit and the control unit are combined together.

13. The controller as claimed in claim 7, wherein the display unit and the control unit are combined together.

14. The controller as claimed in claim 8, wherein the display unit and the control unit are combined together.

15. The controller as claimed in claim 9, wherein the display unit and the control unit are combined together.

16. The controller as claimed in claim 4, wherein the control unit is a control panel with buttons.

17. The controller as claimed in claim 5, wherein the control unit is a control panel with buttons.

18. The controller as claimed in claim 6, wherein the control unit is a control panel with buttons.

19. The controller as claimed in claim 7, wherein the control unit is a control panel with buttons.

20. The controller as claimed in claim 8, wherein the control unit is a control panel with buttons.
